(19) United States
(12) Patent Application Publication
(10) Pub. No.: US 2025/0218437 A1
(43) Pub. Date: Jul. 3, 2025

(54) System and Method for Voice Assistance in a Computer Application

(71) Applicant: Elevance Health, Inc., Indianapolis, IN (US)

(72) Inventors: Devarakonda Durga Prakash, Hyderabad (IN); Ankur Chandra, Hyderabad (IN)

(21) Appl. No.: 18/987,057

(22) Filed: Dec. 19, 2024

Related U.S. Application Data
(60) Provisional application No. 63/616,139, filed on Dec. 29, 2023.

(51) Int. Cl. G10L 15/22; G06F 21/32

(52) U.S. Cl. CPC G10L 15/22; G06F 21/32; G10L 2015/223

(57) ABSTRACT

One aspect includes an application capable of receiving voice commands and non-voice commands: persistently displaying a user interface element configured to enable a voice command listening mode in the application; activating the voice command listening mode in response to receiving a non-voice user input interaction; receiving a spoken natural language input; converting the audio data to text data; performing natural language understanding on the text data to convert the text data to a structured request; determining whether the structured request relates to a command, that would also be available to be executed in the application in response to a non-voice input; and in response to a determination that it does, executing the command, and changing the display in response to the command, in substantially the same manner in which the display would be changed in response to executing the command in response to the non-voice input.

### RELATED APPLICATIONS

This application claims priority to U.S. Provisional Application No. 63/616,139, titled “Systems and Methods for Voice Assistance in a Computer Application,” filed Dec. 29, 2023, which is hereby incorporated by reference in its entirety.

### TECHNICAL FIELD

The disclosed implementations relate generally to automatic speech recognition, relates more specifically to automatic speech recognition in the context of a website or a software application that is visible on a computing device having a display, and relates more specifically to applications relating to secure or private data, and to the use of the voice assistant to streamline navigation in the application across multiple levels of navigation.

### BACKGROUND

Traditional navigation methods in user facing computer applications, e.g. smartphone applications and web applications, is often cumbersome and difficult for some users. According to internal metrics at some companies nearly 40% of user actions and time spent on the app are only for navigation. Customer feedback also suggests that certain members who may not be used to interacting with computer applications, such as older users, may struggle with navigation.

Speech recognition systems allow humans to interact with computing devices using their voices. Such systems employ techniques to identify the words spoken by a human user based on the various qualities of a received audio input. Speech recognition combined with natural language understanding enable speech-based user control of a computing device to perform tasks based on the user's spoken commands. Speech recognition and natural language understanding processing techniques may be referred to collectively or separately herein as speech processing. Speech processing may also involve converting a user's speech into text data which may then be provided to various text-based software applications.

Speech processing may be used by computers, hand-held devices, telephone computer systems, kiosks, and a wide variety of other devices to improve human-computer interactions.

It may be advantageous to integrate speech processing with more traditional, e.g. screen based, software applications. Speech processing may be used to simplify navigation, especially for users not familiar with traditional methods of user input for software applications. It may also be advantageous to integrate speech processing with chatbot assistance to present the user with a common and familiar interface. It may also be advantageous to allow access to the chatbot interface for developers of future features of the application.

In the health care industry voice assistants can be beneficial in, for example, engagement with conversational Artificial Intelligence (“AI”), patient education, streamlined clinical workflows, improved accessibility, adherence and compliance, care for seniors, and voice based diagnostics.

Although voice-based technologies are known in the art, challenges with leveraging third party applications into secure applications such as health care, may include Data encryption, secure data transmission protocols, role-based access control, and other security measures, HIPAA compliance, seamlessness of navigation, and cost.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a non-transitory computer-readable medium containing programming instructions that are configured to cause a computing device capable of receiving voice and non-voice user inputs. The non-transitory computer-readable medium containing programming instructions also includes while running an application on the computing device, the application being visible on a display of the computing device, the application being capable of receiving voice commands and non-voice commands, the application being further configured to access private data: displaying a user interface element in the application, the user interface element being configured to enable a voice command listening mode in the application; activating the voice command listening mode in response to receiving a non-voice user input interaction with the user interface display element in the application; receiving audio data representing a spoken natural language input into the computer application; converting the audio data to text data, the text data including text representing at least one word spoken in the audio data; performing natural language understanding on the text data to convert the text data to a structured request; determining whether the structured request relates to a command, executable in the application, that would also be available to be executed in the application in response to a non-voice input. The instructions also includes in response to a determination that the structured request relates to a command executable in the application. The instructions also includes determining whether the command would result in a display of private information relating to an identified person. The instructions also includes upon a determination that the command would result in a display of private information relating to an identified person. The instructions also includes determining an identity of a user submitting the spoken natural language input, using voice biometrics. The instructions also includes determining whether the user is authorized to receive private data relating to the person. The instructions also includes upon a determination that the user is not authorized to receive private data relating to the person, displaying a message to the user that the command will not be executed. The instructions also includes upon a determination that the user is authorized to receive private data relating to the person, executing the command, and changing the display in response to the command, in substantially the same manner in which the display would be changed in response to executing the command in response to the non-voice input. The instructions also includes where the command is available to be executed in the application in response to a plurality of non-voice inputs relative to the current state of the application, and where the command is available to be executed in the application in response to a single voice input after the voice command listening mode is activated. Other embodiments of this aspect include corresponding computer systems, apparatus, and computer programs recorded on one or more computer storage devices, each configured to perform the actions of the methods.

One general aspect includes a non-transitory computer-readable medium containing programming instructions that are configured to cause a computing device capable of receiving voice and non-voice user inputs. The non-transitory computer-readable medium containing programming instructions also includes while running an application on the computing device, the application being visible on a display of the computing device, the application being capable of receiving voice commands and non-voice commands: persistently displaying a user interface element in the application, the user interface element being configured to enable a voice command listening mode in the application; activating the voice command listening mode in response to receiving a non-voice user input interaction with the user interface display element in the application; receiving audio data representing a spoken natural language input into the computer application; converting the audio data to text data, the text data including text representing at least one word spoken in the audio data; performing natural language understanding on the text data to convert the text data to a structured request; determining whether the structured request relates to a command, executable in the application, that would also be available to be executed in the application in response to a non-voice input; and in response to a determination that the structured request relates to a command executable in the application, executing the command, and changing the display in response to the command, in substantially the same manner in which the display would be changed in response to executing the command in response to the non-voice input.

Other embodiments of this aspect include corresponding computer systems, apparatus, and computer programs recorded on one or more computer storage devices, each configured to perform the actions of the methods.

Implementations may include one or more of the following features. The medium where the application is used to access private data, and where the structured request would result in a display of private information relating to an identified person, the method may include, the steps of: prior to executing the command: determining an identity of a user submitting the spoken natural language input; determining whether the user is authorized to receive private data relating to the person; and upon a determination that the user is not authorized to receive private data relating to the person, displaying a message to the user that the command will not be executed. The step of determining an identity of the user further may include using voice biometrics to identify the voice of the user. The structured request relates to a relative location, and where the structured request does not identify an absolute location, the computing device being configured to further perform the steps of identifying a location of the computing device, and executing the command using the location of the computing device as an input to the command. The medium the computing device being configured to further perform the steps of, in response to a determination that the structured request does not relate to a command executable in the application, displaying a message in lieu of executing the command. The command is available to be executed in the application in response to a plurality of non-voice inputs relative to the current state of the application, and where the command is available to be executed in the application in response to a single voice input after the voice command listening mode is activated. The step of determining whether the structured request relates to a command, executable in the application, that would also be available to be executed in the application in response to a non-voice input, further may include querying a knowledge graph with a query relating to the structured request, where the knowledge graph has been trained using a machine learning model to recognize commands that are available to be executed in the application. The medium the computing device being configured to further perform the steps of, before performing natural language understanding on the text data: detecting a language of at least one of the audio data or the text data; determining whether the language is the same as a reference language for natural language understanding; upon a determination that the language is not the same as the reference language, performing a translation from the language to the reference language. Implementations of the described techniques may include hardware, a method or process, or computer software on a computer-accessible medium.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a block diagram illustrating an implementation of a system for virtual assistant enhanced access of private information, in accordance with one embodiment of the present disclosure.

FIG. 2 is a block diagram illustrating an implementation of a system for a voice assistant for an application, that includes enhanced navigation and access to private information, in accordance with an exemplary embodiment of the present disclosure.

FIG. 3 is a flow diagram illustrating an implementation of a method for a voice assistant for an application, that includes enhanced navigation and access to private information, in accordance with an exemplary embodiment of the present disclosure.

FIG. 4 is an exemplary process flow diagram, for the operation of one embodiment of the invention.

FIGS. 5A through 5D are exemplary user interface figures of an application in accordance with an exemplary embodiment of the present disclosure.

FIG. 6 is a flow diagram of a method in accordance with an exemplary embodiment of the present disclosure.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first electronic device could be termed a second electronic device, and, similarly, a second electronic device could be termed a first electronic device, without departing from the scope of the various described implementations. The first electronic device and the second electronic device are both electronic devices, but they are not necessarily the same electronic device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

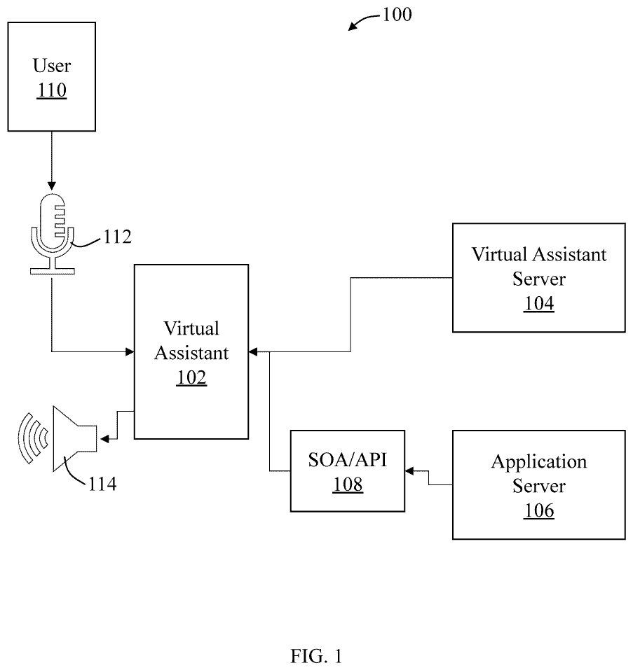

Referring to FIG. 1, there is shown a block diagram illustrating an implementation of a system for virtual assistant enhanced access of private information, generally designated 100. While some example features are illustrated, various other features have not been illustrated for the sake of brevity and so as not to obscure pertinent aspects of the example embodiments disclosed herein. To that end, as a non-limiting example, the system for virtual assistant enhanced access of private information 100, referred to herein as system 100, may include one or more computing devices in communication with one or more networked servers. In one embodiment, the system 100 comprises a virtual assistant enabled device 102, a virtual assistant server 104 in communication with the virtual assistant enabled device 102, and an application server 106 in communication with the virtual assistant enabled device 102.

The virtual assistant enabled device 102 may be a computing device configured to receive a user input (e.g., voice commands from a user 110) and provide an output in response to the user input. The virtual assistant enabled device 102, referred to herein as the virtual assistant 102, may be one or more computing devices having stored thereon executable code for running applications and/or performing tasks in response to commands (e.g., spoken) from a user 110. The virtual assistant enabled device 102 may include one or more processors and/or one or more memory units configured to store and execute executable code for performing the virtual assistant tasks. The virtual assistant 102 may be a smart phone, smart speaker, a computer, a laptop computer, a tablet device, a netbook, an internet kiosk, a personal digital assistant, a mobile phone, a gaming device, or any other computing device. In some embodiments, the virtual assistant 102 includes an audio input device 112 (e.g., a microphone) and an audio output device 114 (e.g., a speaker). In some embodiments, one or more of the audio input device 112 and/or audio output device 114 are integrated with the virtual assistant 102 (e.g., a smart speaker having an integrated microphone and/or speaker). In some embodiments, one or more of the audio input device 112 and/or audio output device 114 are external to the virtual assistant (e.g., headphones connected to a smartphone).

In some embodiments, the virtual assistant 102 may be connected to or include a graphical display screen (e.g., touch screen, LED screen, LCD screen) for displaying outputs to a user. In some embodiments, the virtual assistant 102 may include one or more light sources (e.g., an LED light source) configured to emit a light in response to receiving data from one or more external servers. For example, the light source may emit a light in response to receiving updated information from one or more external servers relating to the user of the virtual assistant 102. In this manner the virtual assistant 102 may be configured to display a visual indication to the user that information has been received which pertains to the user. In some embodiments, the virtual assistant 102 is a device that is compliant with the Health Insurance Portability and Accountability Act (HIPAA) standards for protected health information. In some embodiments, the virtual assistant 102 is a device that is compliant with one or more data protection and/or privacy standards, such as for example, but not limited to, the General Data Protection Regulation (GDPR), the Act on the Protection of Personal Information (APPI), and the Data Protection Act.

In some embodiments, the virtual assistant 102 is a device configured to be operated by a user 110 using spoken commands. In some embodiments, the virtual assistant 102 is configured to recognize a plurality of spoken commands (also referred to as utterances). For example, a user 110 may speak phrases such as “what is the weather”, “listen to jazz”, “what is my schedule”, which the virtual assistant 102 is configured to recognize. In some embodiments, the virtual assistant 102 is configured to perform tasks associated with the spoken commands. For example, in response to a spoken command from a user 110 asking “what is the weather”, the virtual assistant 102 may execute computer executable code for determining weather information (e.g., the temperature) pertaining to the location of the user 110. The virtual assistant 102 may then return the output of the task to the user 110 audibly and/or visually. For example, the virtual assistant 102 may send a signal to the audio output device 114 causing the audio output device 114 to play an audible message including the temperature and weather forecast for the user 110 to hear. It will be understood that not all possible spoken commands and corresponding tasks performed by virtual assistant 102 will be listed for sake of brevity.

In some embodiments, the executable code used to perform tasks may be included in one or more software applications. In some embodiments, the virtual assistant 102 is configured to perform tasks included in a voice-assisted member interface. A voice-assisted member interface may refer to a collection of computer executable code developed to be either freely distributed or sold by an entity other than the original vendor of the virtual assistant 102.

For example, in the above example, the virtual assistant 102 was shown to be capable of retrieving weather information and returning it to a user 110. This functionality may be performed by a collection of computer executable code developed by a vendor of the virtual assistant 102. A voice-assisted member interface may be installed on the virtual assistant 102 such that one or more functionalities is added to the virtual assistant 102. For example, a user 110 may install a voice-assisted member interface for ordering food from a specific restaurant in their local area. The user 110 may provide a spoken command to “order a pepperoni pizza from Joe's” causing the virtual assistant 102 to execute computer executable code included in said voice-assisted member interface to submit an order for a pepperoni pizza at Joe's. The virtual assistant 102 may have a plurality of voice-assisted member interface packages installed thereon each of which being configured to allow the voice-assisted member interface to perform specific functionalities. In some embodiments, the voice-assisted member interface packages may be developed by parties or entities that are not the vendor of the virtual assistant 102 (e.g., a third-party developer).

In some embodiments, the virtual assistant 102 may be in communication with a virtual assistant server 104 which may provide some of the functionality of the virtual assistant 102, remotely over a network such as the internet. In some embodiments, the virtual assistant server 104 is configured to provide a plurality of optional software applications (e.g., voice-assisted member interfaces, software applications developed by the vendor) for installation and use on the virtual assistant 102. In some embodiments, the virtual assistant server 104 may include one or more servers and/or one or more databases for storing data related to users 110 of the virtual assistant 102. In some embodiments, the virtual assistant server 104 may store data relating to a plurality of user accounts, each user account being associated with a user 110 of the virtual assistant 102. For example, a first user may have an account with corresponding data stored on the virtual assistant server 104 and a second user may have a different account with corresponding data stored on the virtual assistant server 104. The data corresponding to an account may include information about the user 110 such as: user specific voice biometric data, user authentication credentials (e.g., password, username, PIN), the name of the user, and any other information about the user.

In some embodiments, the virtual assistant 102 is configured to associate a user 110 with their associated account via one or more authentication means. In some embodiments, the authentication means may include a personal identification number (PIN), voice authentication and/or a password. In some embodiments, the user 110 may provide one or more of the authentication means to virtual assistant 102 such that the user 110 is authenticated with their associated account. In some embodiments, the user 110 may be required to be authenticated with their account (e.g., logged in to their account) in order to access the functionalities of the virtual assistant 102. In some embodiments, the virtual assistant 102 may require that a user 110 be authenticated with their associated account before the user 110 is able to access, enable, and/or use the functionality of the virtual assistant 102. For example, one or more functionalities included in software applications provided by the vendor, a third-party and/or the voice-assisted member interface may be accessible via the virtual assistant 102 following user 110 being authenticated with their account. In some embodiments, virtual assistant 102 may be configured to authenticate a user 110 by performing voice biometric authentication. In some embodiments, virtual assistant 102 may be configured to authenticate a user 110 if voice biometric authentication and a valid PIN are provided by the user 110.

In some embodiments, the virtual assistant 102 may be configured to be used by one or more users 110, each having a different associated vendor account. In some embodiments, the virtual assistant 102 may be configured to compare the vocal attributes of the user 110 to the voice biometric data stored on the virtual assistant server 104 in order to distinguish between different users 110. For example, a first user may speak a voice command to virtual assistant 102 and the virtual assistant may compare the vocal attributes of the received voice command to voice biometric data associated with the first user's account to determine whether the voice command was generated by the first user.

In some embodiments, the virtual assistant 102 may be in communication with an application server 106 associated with an application having one or more voice-assisted member interfaces configured to be installed on the virtual assistant 102. In some embodiments, the application may be associated with an entity other than the vendor of the virtual assistant 102. In some embodiments, the application may be associated with a provider such as a healthcare provider and/or an entity which provides health insurance. In some embodiments, the application server 106 may be one or more servers and/or databases having stored thereon data associated with a plurality of provider accounts. In some embodiments, a user 110 of the virtual assistant 102 may also have an associated provider account. In some embodiments, the data associated with a provider account may include protected health information specific to a user 110. For example, the application server 106 may store data such as: an insurance policy, insurance premiums, primary care providers, user's medical history information, healthcare benefits, prescription medication information, healthcare related appointments, healthcare benefit plan information (e.g., HSA, HRA, HSA+, HRA+, FSA, and LPFSA), user information (e.g., name, age, weight, height, gender, address), and any other information relating to the user and/or the user's healthcare. In some embodiments, the application server 106 may store data indicating whether a user 110 has a valid insurance policy provided by the application server. In some embodiments, the application server 106 may store healthcare data not specific to any one user 110. For example, the application server 106 may store data relating to a listing of healthcare providers which are a part of the providers healthcare network, a healthcare glossary including definitions of healthcare and healthcare insurance related terms.

In some embodiments, a user 110 may be required to provide authentication credentials before the user can access their protected health information associated with their provider account. In some embodiments, the voice-assisted member interface installed on virtual assistant 102 may be configured to authenticate a user 110 with their associated provider account using one or more of voice biometrics, authentication credentials specific to the provider account, and/or a PIN. In some embodiments, the voice-assisted member interface may be configured to create an association between a user's provider account and other accounts belonging to the user. In some embodiments, the virtual assistant 102 may be configured to provide access to a user's 110 protected health information, provided the user's 110 provider account and other accounts are associated with one another.

A voice based assistant may include the following elements or modules. Speech to text (STT) engine for converting voices into text, e.g for speech as an input. A text to speech (TTS) engine, for converting text to speech, e.g. for speech as an output. Tagging, to understand what the text means, which can include intent classification and other natural language understanding techniques. A voice assistant may also include a noise reduction engine. A voice assistant may also include Voice biometrics, which may be used for authentication, to allow the application to recognize a particular user, to provide personalized answers and also to guard privacy, e.g. to prevent an unauthorized user from seeing or hearing private, e.g. medical, information.

A voice assistant may also include a user interface. A user interface may in some embodiments include a voice, and a call out. A voice may speak outputs to the user. A call out may deliver outputs to the user without speaking, e.g. by displaying them.

A voice assistant may also include a speech compression engine, which may be used to compress the voice of the users so it can reach the server faster.

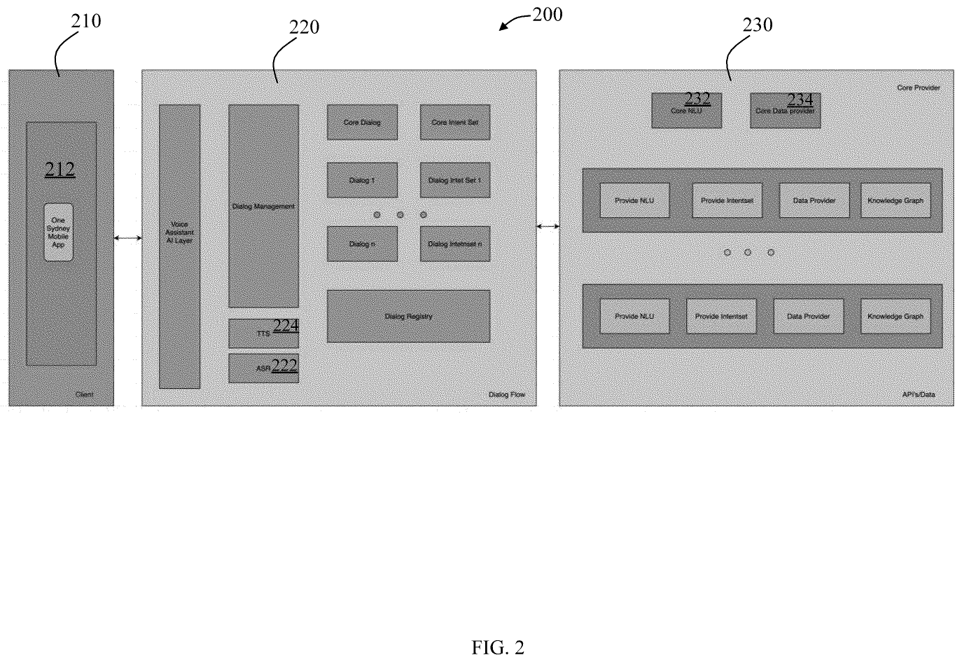

Turning now to FIG. 2, a block diagram of a system architecture layer 200 for a voice assistant is disclosed. Architecture layer 200 includes a client layer 210, a dialog layer 220, and an Application Programming Interface (API) layer 230. Architecture layer 200 may be implemented using computer executable code that may be stored in a memory in, and/or executed by, one or more of the components of system 100 of FIG. 1. Client layer 210 may, in some embodiments, be stored within virtual assistant 102. Dialog layer 220 may, in some embodiments, be stored in and/or executed by application server 106. API layer 230 may, in some embodiments, be stored in and/or executed by application server 106. In some embodiments it may also be stored in and/or executed by SOA/API 108.

Client layer 210 contains most of the components that are involved in interfacing with the user. The client layer may in some embodiments be or include a client software application 212, e.g. a smartphone application or a web application, by which the user may access content. The content accessed by the user in software application 212 may include generally available content and may also include content personalized to individual users and/or groups of users such as families. Personalized content may include content with privacy considerations, such as health care or financial information.

Application 212 may be configured to run on a computing devices such as those known in the art, e.g. a computer, a tablet, a smartphone, a smart watch, or other computing device, any of which may include a display for user facing content. Such a computing device may also have a non-voice user input device included in or attached to it, such as a keyboard, a mouse, or a touch screen. Such computing device may also have a voice input device included in or attached to it, such as a microphone. Such a computing device may also have a voice output device, such as a speaker. In some embodiments, application 212 may run on the computing devices, but some of its functions may be performed by one or more remote computing devices, e.g. web or application servers.

Dialog layer 220 contains the main Natural Language Processing (NLP) components to drive the interaction with the user. Dialog layer 220 may include an automatic speech recognition (ASR) component 222. Automatic speech recognition component 222 may be used to convert voices into text, e.g for use of speech as an input to, e.g. artificial intelligence command evaluation and information requests, e.g. in application 212.

Automatic speech recognition (ASR) is a field of computer science, artificial intelligence, and linguistics concerned with transforming audio data associated with speech into text representative of that speech. Similarly, natural language understanding (NLU) is a field of computer science, artificial intelligence, and linguistics concerned with enabling computers to derive meaning from text input containing natural language. ASR and NLU are often used together as part of a speech processing system. Text to speech (TTS) component 224 may perform the opposite function, by converting text to speech, so that answers to user questions, and follow up questions, that may be generated in a text format, may be presented to users via a spoken voice.

TTS is a field of computer science concerning transforming textual and/or other data into audio data that is synthesized to resemble human speech. Natural language processing (NLP) may include ASR, NLU, TTS, and/or other operations involved in the processing of natural language inputs or outputs.

API layer 230 may be used to provide a service that provides access to the voice assistant, for data providers, external services, and Intelligent Process Automation (“IPA”) providers. IPA combines process redesign, robotic process automation, and machine learning to improve business processes and automate processes. API layer 230 may be used to extend the voice assistant provided by the dialog layer to other applications other than application 212 of client layer 210. This may include third party applications, or newly developed applications, which may be able to use API layer 230 to add voice assistant capability to other applications.

API layer 230 may include natural language understanding (NLU) module 232, which may be used to convert the user's spoken question, in a natural language such as English, into a semantic command or request to be interpreted and fulfilled by, e.g., application 212. NLU module 232 may generate NLU hypotheses for the skill systems. If text data is received, NLU module 232 may perform NLU processing on the received text data to generate the NLU hypotheses. If audio data is received, NLU module 232 may perform ASR processing on the received audio data to generate text data, and may perform NLU processing on the generated text data to generate the NLU hypotheses. Alternatively, if the first data is audio data, NLU module 232 may perform spoken language understanding (SLU) processing on the received audio data to generate the NLU hypotheses (without first converting the audio data to text data).

NLU module 232 may also attempt to make a semantic interpretation of the phrase(s) or statement(s) represented in the received text data, which may be accomplished using an artificial intelligence and/or machine learning algorithm. The machine learning algorithm may be implemented using Tensor Flow, which is an end-end machine learning platform. Business logics s may be handled by using Algorithmic-Artificial Intelligence/Machine learning approach. The tensor flow platform may utilize AI/ML capability for voice-based assistance.

NLU module 232 may determine one or more meanings associated with the phrase(s) or statement(s) represented in the text data based on words represented in the text data. The NLU module 232 may then determine an intent representing an action that a user desires be performed as well as pieces of the text data that allow, e.g., application 212, to execute the intent. For example, if the text data corresponds to “show my ID card,” the NLU module 232 may determine an <IDCard> intent and may identify a person associated with “my” based on authentication, as discussed below. For further example, if the text data corresponds to “show claims for my son,” NLU module 232 may determine a <ClaimsList> intent. NLU module 232 may output NLU results data, which may include tagged text data, indicators of intent, etc.

NLU module 232 may also map IPA intent sets to intent sets in Dialog layer 220. IPA intent sets are labels that may be used to identify context of what the user is asking. Dialog layer sets may then be used to drill down to the sub intents, e.g. from conversational flow, that can be further mapped back to the IPA level intents so the assistant can determine the specific request.

API layer 230 may also include core data provider 234, which may include knowledge graphs or other databases that may be queried in response to a user input, e.g. a voice input. In some embodiments, core data provider 234 may contain application data, which may be used to train NLU module 232. In some embodiments, API layer 230 does not generate or maintain source data that is used to query. However, with the continuous training of Machine Learning models, NLU module 232 can mature over time, to gain more accuracy on the users' ask, as core data provider 234 is updated with fresher application data.

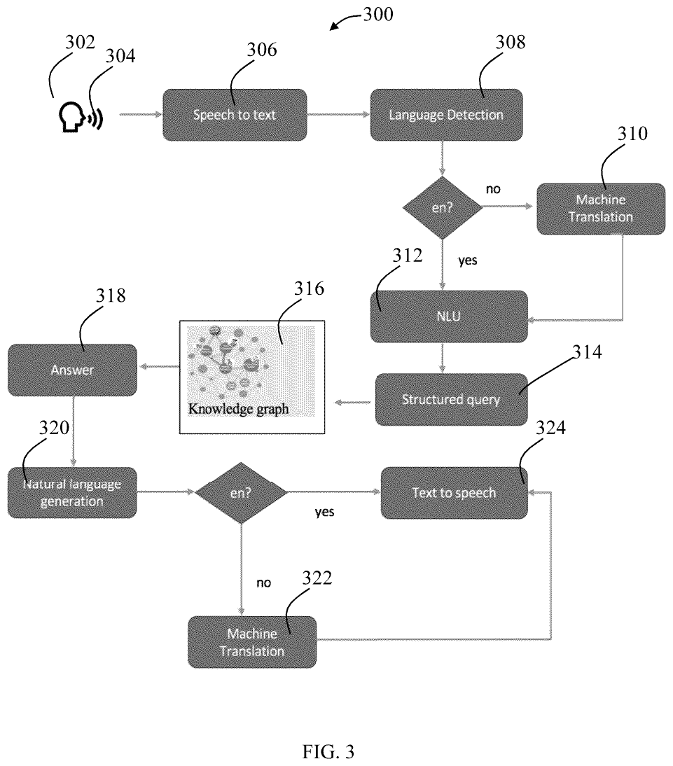

Turning now to FIG. 3, a flow diagram illustrating an implementation of a method 300 for a voice assistant for an application, that includes enhanced navigation and access to private information, in accordance with an exemplary embodiment of the present disclosure is shown. Method 300 may be used in system 200. Portions of method 300 may be included in dialog layer 220 and other portions may be included in API layer 230.

In method 300, a user 302 uses his or her voice to speak (304) an utterance into, e.g., a voice based input of a computing device, such as a microphone. In some embodiments, a voice command listening mode may be activated by user 302 prior to the user voicing the utterance. In some embodiments, a voice command listening mode may be activated by interacting with an on-screen user input prompt, such as a button.

The utterance may then be converted (306) to text, e.g. using automatic speech recognition component 222. As discussed above with reference to FIG. 2, the text created by automatic speech recognition component 222 allows the computer to parse the utterance by the user to determine whether it can be acted upon and, if so, how.

A natural language of the text created in step 306 is then detected (308), e.g. by a language detection module. The system may in some embodiments be implemented primarily in English or another reference natural language. Accordingly, a detection may be performed to see if the words in the utterance are English words.

If the words are in a language other than English, the utterance may be machine translated (310) into English, or another reference language.

If the words in the utterance are in English, they are then further analyzed (312) using Natural Language Understanding (NLU). If the words in the utterance are not in English, they are analyzed (312) using NLU after being translated (310) to English.

NLU analysis (312) is used to transform the utterance, in a natural language, into a structured query (314), which may in some embodiments be formatted in a Structured Query Language (SQL). Structured Query Language (SQL) is a standardized language for defining and manipulating data in a relational database. In accordance with the relational model of data, the database is perceived as a set of tables, relationships are represented by values in tables, and data is retrieved by specifying a result table that can be derived from one or more base tables.

Executable structured queries (314) may be prepared for execution. Since the user input is a spoken utterance, a structured query may require preparation from an input in a natural language, as opposed to being prepared based on code written by developers having more familiarity with SQL, which may exist behind a more traditional and less open ended user interface, such as a plurality of buttons. In some embodiments, structures queries (314) may be prepared from the user's natural language utterance, or the machine translation of the utterance, using Tensor Flow. Tensor Flow is an end-to-end machine learning platform. The business logics may be handled by using Algorithmic-Artificial Intelligence/Machine learning approach. The Tensor Flow platform may utilize the AI/ML capability for voice-based assistance.

Structured queries (314) may be applied to a knowledge graph 316, which may be built using a language agnostic method in some embodiments or a language aware method in other embodiments. Knowledge graph (316) may contain answers to structured queries, e.g., relating to the commands and information available in application 212 of client layer 210. As discussed above, knowledge graph (316) may be built using machine learning and/or artificial intelligence, and may be trained on a training set of structured queries relating to elements of application 112, including frequency user commands and requests.

Structured query (314), as queried upon knowledge graph (316), may result in an answer (318). Answer (318) may be in the form of a command that can be executed by application 212 in response to the user utterance of step (304). User Commands may be configured for differently for different applications. Such configuration may allow the virtual assistant to respond to each command with voice output or response on the display. Application specific configuration may be useful in ensuring compliance with user privacy and security guidelines that govern relevant industries. For example, a user command about claim information for a medical insurance provider, the virtual assistant may be configured to respond only via display/text output instead of voice, as claim information may be considered private or sensitive. However, a command to look for medical providers in a locality, may be delivered via a voice output, because risk of overhearing may be lessened for provider names and addresses compared to medical claim information. Use of artificial intelligence and/or machine learning may allow the virtual assistant to contribute to the knowledge management repository from each conversation and assistance provided, which may be used to improve the accuracy of the assistant's responses over time.

In some embodiments, the system may also be configured to deliver a spoken word response to the user, either in lieu of or in addition to the non-voice output such as a command. In some embodiments, the system may be configured to deliver voice output on certain types of commands, and non-voice output on other types of commands, and/or to deliver both voice and non-voice output for certain types of commands.

In the event voice output is desired, answer (318) may be processed further, using natural language generation 320, to translate or otherwise change the answer from the form in which it may be stored in knowledge graph 316, into a natural language, such as the reference natural language, e.g. English, in a text format. If the initial user utterance was in a language that was different from the reference language, the text based natural language answer may be machine translated (322) from the reference language to the language initially used by the user in the utterance. When the text based natural language answer is in the user's preferred language, the text based natural language answer may then be converted (324) to voice using text to speech component 224. The voice based answer may then be output, e.g. via a speaker. The text based answer may also in some embodiments also be output, e.g. on a display.

In the event a non-voice output is called for, e.g. because the user's utterance reflected a command to execute code in the application that results in a change to, e.g., the display, the user's command may then be executed (324). Examples of this may include the user having requested the display of certain information available in the application. This may include an identification card belonging to the user or another person to whom the user is associated, e.g. a family member. This may also include insurance claims data, health care expense data, coverage information, usage information, or the like. Additional examples of a command that may call for a non-voice output may include assisting a user with booking tickets for travel or events, an application for an insurance policy or a premium quotation, or searches for real estate in user specified location, specifications and budget, etc. Customer Relationship management applications may also respond to member queries and provide information as needed, e.g. on the display, which may occur before handing the user's query over to a support agent.

These commands to be executed are different than commands to provide search results as these commands are configured to process information related to the application and provide a response that fulfills the user's request.

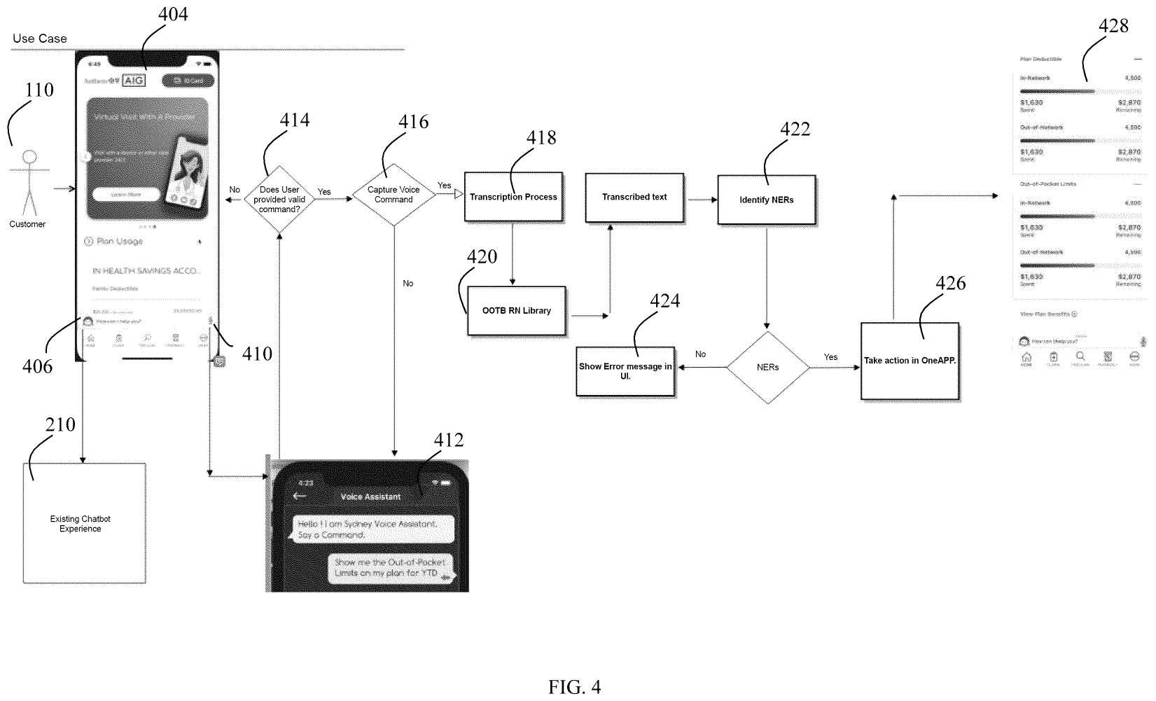

Turning now to FIG. 4, an exemplary process flow diagram, for the operation of one embodiment of the invention, is shown. Customer 110 launches application 212 as shown in FIG. 2, which may include user interface 404. Application 212 which may in some embodiments be a portal application for a health insurer of customer 110. User interface 404 may include a first interface element 406, which may lead a user to a more traditional chatbot experience 408, e.g. including typing questions and receiving text based answers. A second interface element 410, may bring a user to a voice based subsystem of the applications, which may include a user interface, appearing on a screen, with an appearance similar to voice based user interface 412. In some embodiments, user interface element 410 may be persistent across multiple screens in user interface 404 of application 212, such that a user may invoke voice commands regardless of where in user interface 404 of application 212 the user may be at any given time. Voice based subsystem may then receive a user command, by voice and determine (414) if the command is valid. If the command is invalid, the user may be returned to the main interface 404 of application 212. If the command is valid, the command may then be captured (416).

The command may then be transcribed (418) which may involve use of a library 420. As described above, the transcribed text 420 containing the user's command may be parsed (422) for Named Entity Recognition (“NER”), to recognize whether the command includes named entities known to the system. In an insurance context, named entities may include health care providers, insurers, employers, facility names, or the like. Named entities may also include the commands themselves, e.g. names for commands that application 212 is able to execute.

If no Named Entity commands are recognized, an error message may be displayed (424). If a Named Entity command is recognized, the command may then be executed (426) by application 212. The execution of the named entity command may result in a display 428 of a user interface and/or content showing the results of the command requested by customer 402 and executed by application 212. In some embodiments, display 428 is the same display as would appear if the command were executed by more traditional user input, such as clicking, tapping, or typing in response to on screen user interface elements, e.g., in user interface 404. In some embodiments, a single voice command may lead to quicker execution of the user's command, compared to the traditional user interface interaction which may require multiple interactions such as taps, clicks, or the like. Traditional user interface interaction may include nested levels of user interfaces to reach the content requested by the user command, which may be skipped by executing the command using a voice command as disclosed herein.

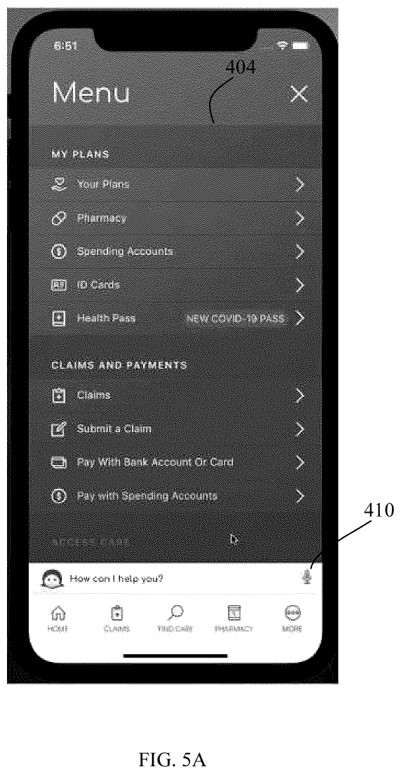

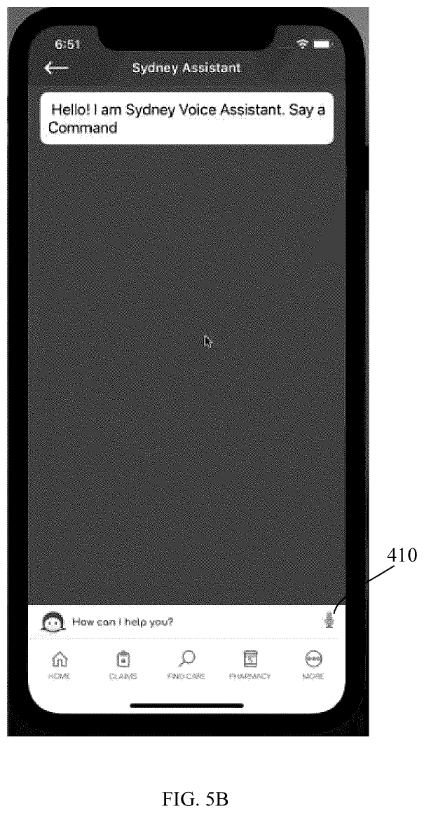

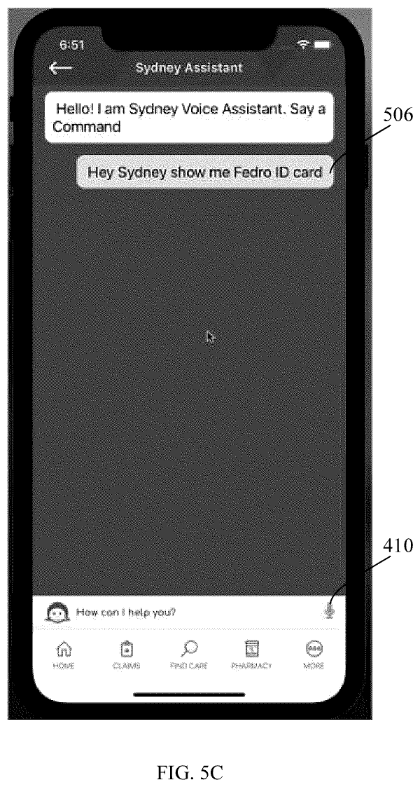

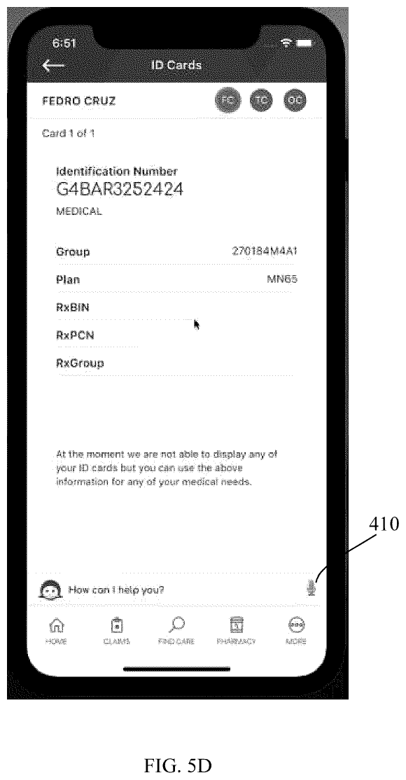

Turning now to FIGS. 5A through 5D, exemplars of a user interface 404 of an application such as application 212, in accordance with an embodiment of the present disclosure. In FIG. 5A, application 212 is a health insurance portal application for patients, as implemented on a smartphone. Persons having skill in the art will understand that the present disclosure may be applicable to other applications, such as banking, finance, etc., applications, and on other platforms such as computers, tablets, web applications, etc. In FIG. 5A, a menu 502, of user interface 404 as shown in FIG. 4, is shown, with commands available to be executed via non-voice inputs, such as interacting with a touch screen on the device where application 212 is running. Persistent user interface element 410 represents to the user that voice command listening mode is always available. In the example of FIG. 5A, persistent user interface element 410 is a microphone, but other imagery may be used. In some embodiments, persistent user interface element 410 may appear in all, substantially all, or the majority of views and contexts within user interface 404 of application 212.

FIG. 5B shows a user interface that appears after voice command listening mode has been activated, e.g. by interacting with persistent user interface element 404. In some embodiments, application 212 may deliver a voice output to indicate to the user that application 212 is ready to listen to commands. In some embodiments, as shown in FIG. 5B, the voice output may also be shown, e.g. simultaneously, to the user as text on the screen 506 in a chat message format or chat user interface. After speaking the initial voice output, the application may then activate a voice input device, such as a microphone, so the user may deliver a voice input. In some embodiments, the act of activating the voice input device may be indicated to the user by a sound effect such as a beeping or ding sound. In this example of FIGS. 5A through 5D, “Sydney” is the name given to the voice assistant.

FIG. 5C shows the same user interface as FIG. 5B, after the user has spoken the user utterance, as described above. In some embodiments, as shown in FIG. 5C, the user utterance may be transcribed on the screen after it is processed by automatic speech recognition component 222. Application 212 may then perform the method as disclosed herein to interpret the user input and convert it, e.g. to a reference language and then to a structured query. In this example, the user utterance is “Hey Sydney show me Fedro ID card.” Here, the system may convert the determine that the language of the utterance is English, which matches the system's reference language. The system may then parse the utterance into a structured query, using natural language understanding. Natural language understanding may use the knowledge that “show . . . ID card” is a function of application 212, and that “Fedro” is the name of a family member of the logged in user, to convert the utterance “Hey Sydney show me Fedro ID card” into a structured query to the knowledge grid, to execute the command to show the ID card of the user's family member, Fedro. The system may then execute the command associated with the utterance, and may, at substantially the same time, present a voice output to the user, such as “taking you there now,” to indicate that the command was understood and will be executed.

In some embodiments, further dialogue may be required before the command may be understood. For example, instead of “Fedro,” the user may have said “show my son's ID card.” The system may then query the knowledge graph and determine that the logged in user has more than one son, and then may ask, e.g. by voice, by on screen text, or both, which son's ID card is being requested.

FIG. 5D shows the result of having executed the command that was the result of the structured query of the knowledge graph, that was itself the result of NLU on the user's utterance. An ID card of a patient, Fedro Cruz, is not shown, because the system was not able to show the ID card, as noted. However, the system shows identifying information relating to Fedro, including his identification number, which demonstrates that the system was able to successfully execute the voice command. Persistent user interface element 404 is present, indicating that application 212 is ready to answer another query from the user.

In some embodiments, the command may be executed with a single voice command, even though, prior to activating voice command listening mode, the user was looking at a part of the applications that was many navigation steps away from ID cards. In this way, the voice assistant can provide a substantially improved navigation experience for the user who may know what he or she wants, but may not be able to locate the path from his or her current place in the application.

In some embodiments, security measures may be taken before executing the command of showing Fedro's ID card. In some embodiments, the user may log in and authenticate his or her identity. In other embodiments, further security measures may be taken, which may include voice biometrics to identify the speaker, and then determine whether the identified speaker is authorized to see private information relating to the person whose data was requested.

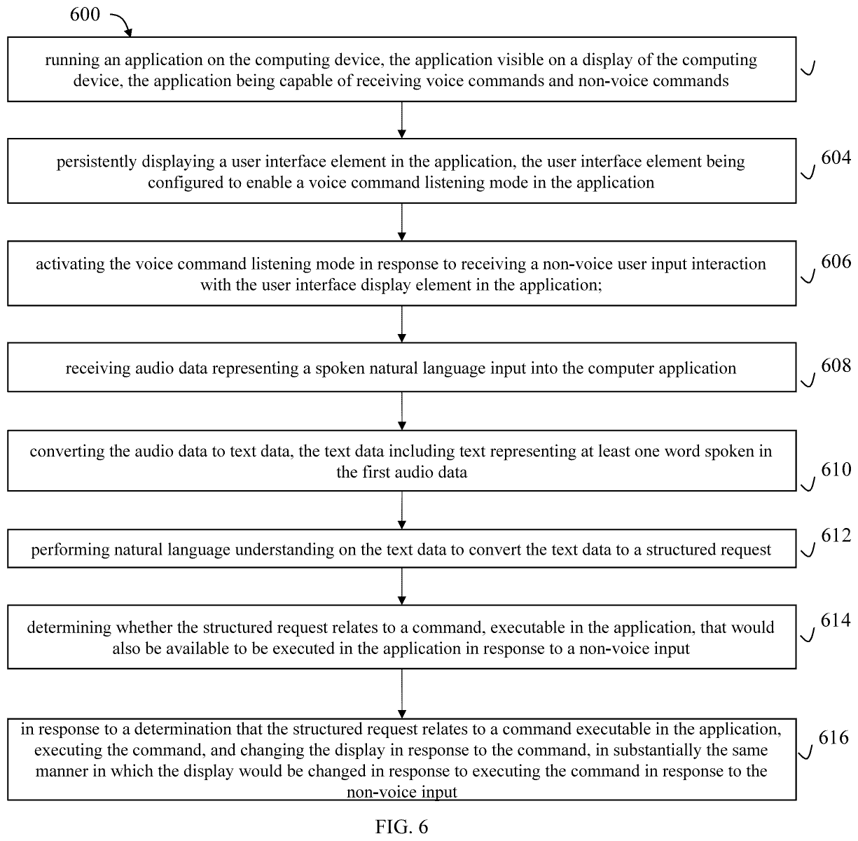

Turning now to FIG. 6, a flow diagram of a method 600 in accordance to an embodiment of the present disclosure is shown. In some embodiments, the method may be implemented via computer executable instructions, which may be stored on a non-transitory computer-readable medium, e.g. in or coupled to a computing device. The method begins with running (602) an application on the computing device, the application visible on a display of the computing device, the application being capable of receiving voice commands and non-voice commands. The application persistently displays (604) a user interface element, the user interface element being configured to enable a voice command listening mode in the application. Voice command listening mode may then be activated (606) in response to receiving a non-voice user input interaction with the user interface display element in the application. Audio data may be received (608), representing a spoken natural language input into the computer application. Audio data may then be converted (610) to text data, the text data including text representing at least one word spoken in the audio data. NLU may be performed (612) on the text data to convert the text data to a structured request. The system may then determine (614) whether the structured request relates to a command, executable in the application, that would also be available to be executed in the application in response to a non-voice input. In response to a determination that the structured request relates to a command executable in the application, the command may be executed (616), which may involve changing the display in response to the command, in substantially the same manner in which the display would be changed in response to executing the command in response to the non-voice input.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations are chosen in order to best explain the principles underlying the claims and their practical applications, to thereby enable others skilled in the art to best use the implementations with various modifications as are suited to the particular uses contemplated.

What is claimed is:

1. A non-transitory computer-readable medium containing programming instructions that are configured to cause a computing device capable of receiving voice and non-voice user inputs, to perform the steps of:
while running an application on the computing device, the application being visible on a display of the computing device, the application being capable of receiving voice commands and non-voice commands, the application being further configured to access private data:
displaying a user interface element in the application, the user interface element being configured to enable a voice command listening mode in the application;
activating the voice command listening mode in response to receiving a non-voice user input interaction with the user interface display element in the application;
receiving audio data representing a spoken natural language input into the computer application;
converting the audio data to text data, the text data including text representing at least one word spoken in the audio data;
performing natural language understanding on the text data to convert the text data to a structured request;
determining whether the structured request relates to a command, executable in the application, that would also be available to be executed in the application in response to a non-voice input; and
in response to a determination that the structured request relates to a command executable in the application,
determining whether the command would result in a display of private information relating to an identified person;
upon a determination that the command would result in a display of private information relating to an identified person determining an identity of a user submitting the spoken natural language input, using voice biometrics;
determining whether the user is authorized to receive private data relating to the person;
upon a determination that the user is not authorized to receive private data relating to the person, displaying a message to the user that the command will not be executed; and
upon a determination that the user is authorized to receive private data relating to the person, executing the command, and changing the display in response to the command, in substantially the same manner in which the display would be changed in response to executing the command in response to the non-voice input;
wherein the command is available to be executed in the application in response to a plurality of non-voice inputs relative to a current state of the application, and wherein the command is available to be executed in the application in response to a single voice input after the voice command listening mode is activated.

2. A non-transitory computer-readable medium containing programming instructions that are configured to cause a computing device capable of receiving voice and non-voice user inputs, to perform the steps of:
while running an application on the computing device, the application being visible on a display of the computing device, the application being capable of receiving voice commands and non-voice commands:
displaying a user interface element in the application, the user interface element being configured to enable a voice command listening mode in the application;
activating the voice command listening mode in response to receiving a non-voice user input interaction with the user interface display element in the application;
receiving audio data representing a spoken natural language input into the computer application;
converting the audio data to text data, the text data including text representing at least one word spoken in the audio data;
performing natural language understanding on the text data to convert the text data to a structured request;
determining whether the structured request relates to a command, executable in the application, that would also be available to be executed in the application in response to a non-voice input; and
in response to a determination that the structured request relates to a command executable in the application, executing the command, and changing the display in response to the command, in substantially the same manner in which the display would be changed in response to executing the command in response to the non-voice input.

3. The medium of claim 2, wherein the application is used to access private data, and wherein the structured request would result in a display of private information relating to an identified person, the steps further comprising:
prior to executing the command:
determining an identity of a user submitting the spoken natural language input;
determining whether the user is authorized to receive private data relating to the person; and
upon a determination that the user is not authorized to receive private data relating to the person, displaying a message to the user that the command will not be executed.

4. The medium of claim 3, wherein the step of determining an identity of the user further comprises using voice biometrics to identify the voice of the user.

5. The medium of claim 2, wherein the structured request relates to a relative location, and wherein the structured request does not identify an absolute location, the computing device being configured to further perform the steps of identifying a location of the computing device, and executing the command using the location of the computing device as an input to the command.

6. The medium of claim 2, the computing device being configured to further perform the steps of, in response to a determination that the structured request does not relate to a command executable in the application, displaying a message in lieu of executing the command.

7. The medium of claim 2, wherein the command is available to be executed in the application in response to a plurality of non-voice inputs relative to the current state of the application, and wherein the command is available to be executed in the application in response to a single voice input after the voice command listening mode is activated.

8. The medium of claim 2, wherein the step of determining whether the structured request relates to a command, executable in the application, that would also be available to be executed in the application in response to a non-voice input, further comprises querying a knowledge graph with a query relating to the structured request, wherein the knowledge graph has been trained using a machine learning model to recognize commands that are available to be executed in the application.

9. The medium of claim 8, wherein:
the knowledge graph is built using a language agnostic method;
the machine learning model is trained on a training set of structured queries relating to elements of the application;
the knowledge graph is continuously updated with fresher application data in core data provider storage; and
the machine learning model is retrained with each knowledge graph update to improve accuracy of users' intent recognition over time.

10. The medium of claim 2, wherein the user interface element:
remains persistent across all navigation levels of the application regardless of current application context;
appears in a consistent location across multiple screens to provide a common point of voice activation;
responds to activation by:
providing an audible sound effect indicating microphone activation;
displaying a chat message format interface showing voice assistant status; and
transitioning the application into a voice input ready state; and
maintains availability for voice activation regardless of the number of preceding navigation steps in the application.

11. The medium of claim 2, the computing device being configured to further perform the steps of, before performing natural language understanding on the text data:
detecting a language of at least one of the audio data or the text data;
determining whether the language is the same as a reference language for natural language understanding;
upon a determination that the language is not the same as the reference language, performing a translation from the language to the reference language.

12. The medium of claim 2, wherein performing natural language understanding comprises:
generating natural language understanding hypotheses using a tensor flow machine learning platform;
determining one or more meanings by parsing the text data for both intent classification and named entity recognition;
mapping identified intents to intent sets in a dialog layer and drilling down to sub-intents from conversational flow to determine a specific request; and
wherein the natural language understanding is performed after determining a language of the text data matches a reference language for the natural language understanding.

13. The medium of claim 2, further comprising:
determining whether the command would expose private health information;
for commands that would not expose private health information, generating both a voice output and a display output, wherein the voice output is generated by:
performing natural language generation to create a natural language response;
converting the natural language response to voice using text-to-speech; and
for commands that would expose private health information, executing the command to change only the display without generating voice output.

14. The medium of claim 2, wherein performing natural language understanding comprises:
parsing the text data using named entity recognition configured specifically for healthcare terminology;
identifying healthcare providers, insurers, facility names, employers, and command terms as named entities;
determining whether the identified named entities include private health information;
determining whether the user is authorized to access any private health information identified; and
executing the command only when the user is authorized to access any identified private health information.

15. The medium of claim 2, wherein the application is a healthcare application that implements data security including data encryption, secure data transmission protocols, role-based access control integrated with voice biometrics, wherein the commands are configured to:
deliver claim information responses only via display output to prevent overhearing of private medical information; and
allow voice output responses for healthcare provider names and locations in a healthcare network.

16. The medium of claim 2, wherein the application includes a voice compression engine configured to:
compress the audio data representing the spoken natural language input before transmission;
transmit the compressed audio data to a server over a network; and
perform speech recognition on the compressed audio data at the server.

17. The medium of claim 2, wherein:
the application comprises a client layer, a dialog layer, and an API layer;
the client layer contains user interface components and is stored within a virtual assistant device;
the dialog layer contains natural language processing components and is stored on an application server; and
the API layer provides access to the voice assistant functionality for data providers and external services.

18. The medium of claim 2, further comprising:
storing voice biometric data associated with a plurality of user accounts on a virtual assistant server;
storing user authentication credentials including passwords, usernames, and PINs associated with the user accounts;
requiring a user to be authenticated with their associated account before accessing functionalities of the application; and
distinguishing between different users by comparing vocal attributes to the stored voice biometric data.

19. The medium of claim 2, wherein:
the application is configured to integrate with both a chatbot interface and a voice interface;
the chatbot interface receives typed questions and provides text-based answers; and
the voice interface and chatbot interface provide a common interface for developers of future features of the application.

20. The medium of claim 2, wherein:
the application includes a light source configured to emit a light in response to receiving updated information from one or more external servers; and
a persistent user interface element for voice command activation remains visible across multiple screens while the light is emitted.
